(19) United States
(12) Patent Application Publication
(10) Pub. No.: US 2026/0292656 A1
(43) Pub. Date: Sep. 24, 2026

(54) STARTING A NON-INTEGRITY TIMER IN LOCALIZED SERVICES IN MOBILE COMMUNICATIONS

(71) Applicant: MediaTek Singapore Pte. Ltd., Singapore (SG)

(72) Inventors: Puneet ., Bengaluru (IN); Yuan-Chieh LIN, Hsinchu City (TW)

(73) Assignee: MediaTek Singapore Pte. Ltd., Singapore (SG)

(21) Appl. No.: 19/474,207

(22) PCT Filed: Aug. 28, 2024
(86) PCT No.: PCT/CN2024/115015

§ 371 Date: Oct. 10, 2025

(30) Foreign Application Priority Data
Sep. 25, 2023 (IN) 202321064280

(51) Int. Cl. H04W 48/04; H04W 64/00; H04W 88/06

(52) U.S. Cl. CPC H04W 48/04; H04W 64/006; H04W 88/06

(57) ABSTRACT

Techniques pertaining to starting a non-integrity timer in localized services in mobile communications are described. In one scenario, an apparatus (e.g., a user equipment (UE)) receives a reject message without integrity protection and with a specific cause value. In response to the receiving, the apparatus starts a timer T3247 with a random value uniformly drawn from a range with respect to localized services in a standalone non-public network (SNPN). In another scenario, the apparatus adds an SNPN to a list of forbidden SNPNs. Then, the apparatus starts a timer T3245 in an event that the timer T3245 is not running.

### CROSS REFERENCE TO RELATED PATENT APPLICATION(S)

The present disclosure claims the priority benefit of Indian Patent Application No. 202321064280, filed 25 Sep. 2023, the content of which herein being incorporated by reference in its entirety.

### TECHNICAL FIELD

The present disclosure is generally related to mobile communications and, more particularly, to starting a non-integrity timer in localized services in mobile communications.

### BACKGROUND

In wireless communications such as mobile communications under the current 3^{rd} Generation Partnership Project (3GPP) specification, if a user equipment (UE) receives a REGISTRATION REJECT or SERVICE REJECT message without integrity protection with a 5^{th} Generation Mobility Management (5GMM) cause value #3, #6, #7, #12, #13, #15, #27, #72, #74, or #75 before a network has established secure exchange of non-access-stratum (NAS) messages for an N1 NAS signaling connection, the UE is to stop timer T3510 or T3517, if running. Additionally, the UE is to start timer T3247 (e.g., per 3GPP Technical Specification (TS) 24.008) with a random value uniformly drawn from a range between: (a) 15 minutes and 30 minutes for the 5GMM cause value #74; or (b) 30 minutes and 60 minutes for other 5GMM cause values.

The UE starts the T3247 timer and a reject message is received without integrity protection for certain causes so that, after certain duration (e.g., T3247 expiry), the UE can clear the non-integrity attempt counters, remove a standalone non-public network (SNPN) from a forbidden list or set each entry of the “list of subscriber data”. However, when the random value is calculated and T3247 expires after the end time point of the current valid time period for localized services, then there would not be any use to start T3247 since the UE would not be able to attempt on the same SNPN periodically after non-integrity protection reject messages. Therefore, there is a need for solutions of starting a non-integrity timer in localized services in mobile communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions pertaining to starting a non-integrity timer in localized services in mobile communications. It is believed that implementations of one or more of the schemes proposed herein may address or otherwise alleviate the issues described above.

In one aspect, a method may involve a UE receiving a reject message without integrity protection and with a specific cause value. The method may also involve the UE starting, responsive to the receiving, a timer T3247 with a random value uniformly drawn from a range with respect to localized services in an SNPN.

In another aspect, a method may involve a UE adding an SNPN to a list of forbidden SNPNs. The method may also involve the UE starting, responsive to the adding, a timer T3245 in an event that the timer T3245 is not running.

It is noteworthy that, although the description provided herein may be in the context of certain radio access technologies, networks, and network topologies such as 5^{th} Generation (5G)/New Radio (NR)/Beyond Fifth-Generation (B5G) mobile communications, the proposed concepts, schemes and any variation(s)/derivative(s) thereof may be implemented in, for and by other types of radio access technologies, networks and network topologies such as, for example and without limitation, 4^{th} Generation (4G)/Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of a second example process in accordance with an implementation of the present disclosure.

FIG. 4 is a flowchart of a second example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to starting a non-integrity timer in localized services in mobile communications. According to the present disclosure, a number of possible solutions may be implemented separately or jointly. That is, although these possible solutions may be described below separately, two or more of these possible solutions may be implemented in one combination or another.

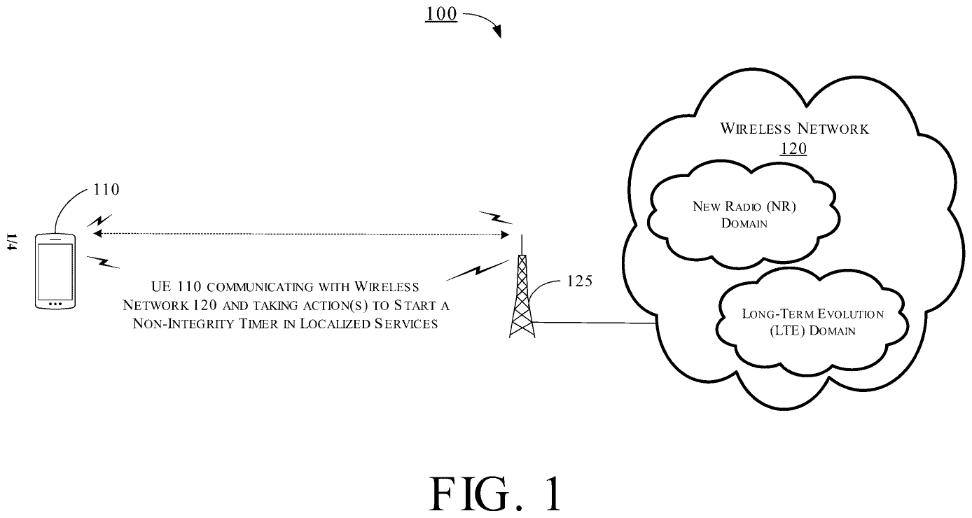

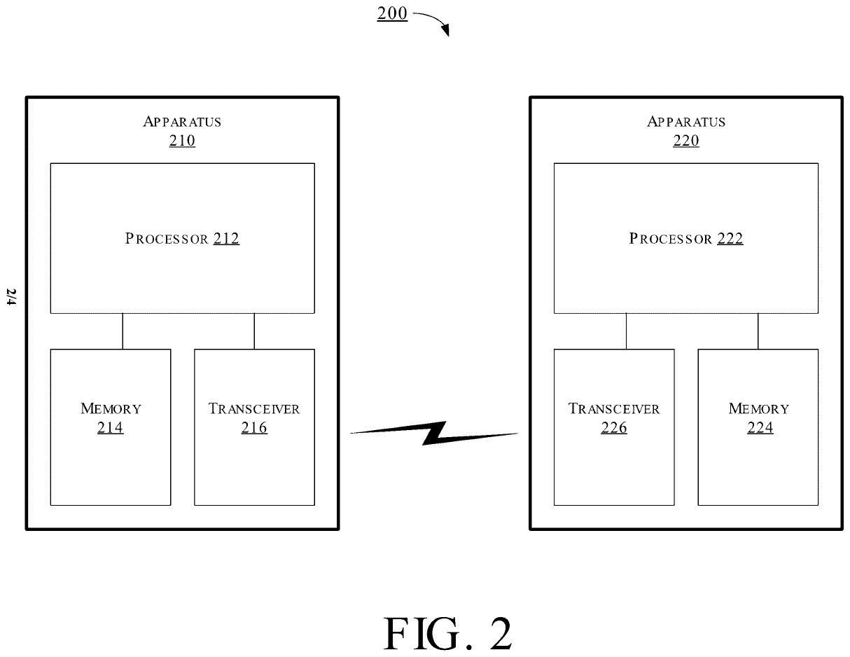

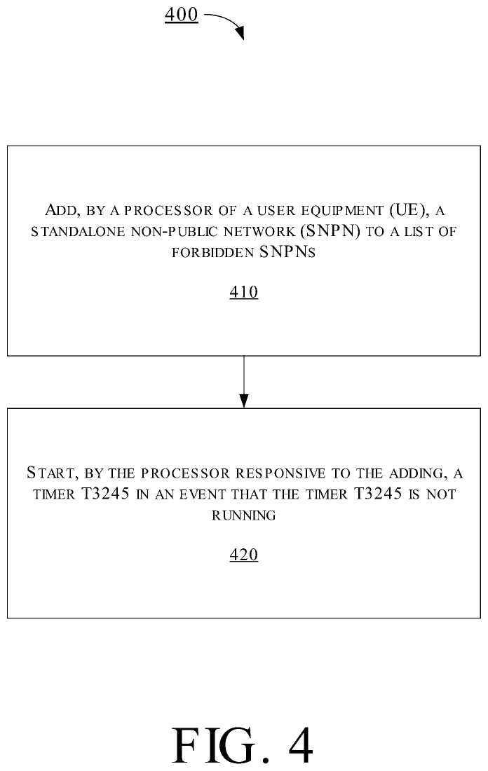

FIG. 1 illustrates an example network environment 100 in which various solutions and schemes in accordance with the present disclosure may be implemented. FIG. 2~FIG. 4 illustrate examples of implementation of various proposed schemes in network environment 100 in accordance with the present disclosure. The following description of various proposed schemes is provided with reference to FIG. 1~FIG. 4.

Referring to FIG. 1, network environment 100 may involve a UE 110, such as a mobile device or smartphone, in wireless communication with a wireless network 120 as part of a communication network. The wireless network 120 may be a PLMN including 5G/NR domain and 4G/LTE domain. UE 110 may initially be in wireless communication with wireless network 120 via a base station or network node 125 (e.g., an eNB, gNB or transmit-receive point (TRP)). In network environment 100, UE 110 and the wireless network 120 may implement various schemes pertaining to starting a non-integrity timer in localized services in mobile communications in accordance with the present disclosure, as described herein.

It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately. Moreover, as used herein, a lower layer may refer to a layer in the 5GMM protocol stack that is lower than the radio resource control (RRC) layer, such as a packet data convergence protocol (PDCP) layer, a radio control link (RLC) layer, a medium access control (MAC) layer, a physical (PHY) layer, or so forth.

In an automatic SNPN selection mode procedure, UE 110 may select an SNPN, if available and allowable, in the order described below. Firstly, in case that UE 110 supports access to an SNPN providing access for localized services in that SNPN and access for localized services in that SNPN is enabled, then, UE 110 may select an SNPN using the SNPN selection parameters for access for localized services in SNPN in the selected entry of the “list of subscriber data” or associated with a selected public land mobile network (PLMN) subscription. Firstly, UE 110 may consider the SNPN previously selected as result of an entry of each list of SNPNs described below with which UE 110 was last registered, if validity information of the entry is still met. Secondly, UE 110 may consider a list of SNPNs, each SNPN of which broadcasting an indication that access using credentials from a credentials holder is supported and which is identified by an SNPN identity contained in an entry of the “credentials holder controlled prioritized list of preferred SNPNs for access for localized services in SNPN” (in priority order), if the validity information of the entry is met. Thirdly, UE 110 may consider a list of SNPNs, each SNPN of which broadcasting an indication that access using credentials from a credentials holder is supported and which broadcast a group identifier (ID) for network selection (GIN) contained in an entry of the “credentials holder controlled prioritized list of preferred GINs for access for localized services in SNPN” (in priority order), if the validity information of the entry is met. In an event that more than one such SNPN broadcast the same GIN, the order in which UE 110 attempts registration on those SNPNs may be UE-implementation specific.

Under a first proposed scheme in accordance with the present disclosure, when UE 110 receives a registration reject or service reject message without integrity protection and UE 110 starts timer T3247, if an SNPN was not selected according to subclause 4.9.3.1.1 bullet a0) of 3GPP TS 23.122 for the specific access type for which the message was received or there is no next valid time period for the SNPN, then time period for T3247 may be chosen as a random value drawn from a range between: (1) 15 minutes and 30 minutes for 5GMM cause value #74; and/or (2) 30 minutes and 60 minutes for other 5GMM cause values.

Under the proposed scheme, in case that the SNPN was selected according to subclause 4.9.3.1.1 bullet a0) of 3GPP TS 23.122 for the specific access type for which the message was received, then time period for T3247 may be chosen as a random value drawn from a range between: (1) 15 minutes and the end time point of the current valid time period for localized services minus a current time point of UE 110 for 5GMM cause value #74; and/or (2) 30 minutes and the end time point of the current valid time period for localized services minus a current time point of UE 110 for 5GMM cause value #75; and/or (3) a start time point and an end time point of a next valid time period for localized services in the SNPN for 5GMM cause value #74 and/or 5GMM cause value #75 and/or other 5GMM causes; and/or (4) 15 minutes and the end time point of the current valid time period for localized services minus a current time point of UE 110 for 5GMM cause value #74; and/or (5) 30 minutes and the end time point of the current valid time period for localized services minus a current time point of UE 110 for other 5GMM cause values; and/or (6) a current time point of UE 110, and an end time point of the current valid time period for localized services in the SNPN for 5GMM cause value #74 and/or 5GMM cause value #75 and/or other 5GMM causes; and/or (7) a start time point and an end time point of the current valid time period for localized services in the SNPN for 5GMM cause value #74 and/or 5GMM cause value #75 and/or other 5GMM causes; and/or (8) a start time point and an end time point of the next valid time period for localized services in the SNPN for 5GMM cause value #74 and/or 5GMM cause value #75 and/or other 5GMM causes.

As an example, in case that UE 110 receives a REGISTRATION REJECT or SERVICE REJECT message without integrity protection with 5GMM cause value #3, #6, #7, #12, #13, #15, #27, #72, #74, or #75 before wireless network 120 has established secure exchange of NAS messages for the N1 NAS signaling connection, UE 110 may stop timer T3510 or T3517, if running. In case that the SNPN sending the message was selected according to subclause 4.9.3.1.1 bullet a0) or subclause 4.9.3.2.1 bullet a0) of 3GPP TS 23.122 and there is next valid time period(s) for the SNPN, UE 110 may start timer T3247 (e.g., 3GPP TS 24.008) with a random value uniformly drawn from the range between a start time point of a next valid time period for localized services in SNPN and one of the following, depending on the situation. For 5GMM cause value #74, the range may be between the start time point of the next valid time period for localized services in SNPN and 30 minutes after the start time point of the next valid time period for localized services in SNPN, if the next valid time period is longer than 30 minutes. Alternatively, for 5GMM cause value #74, the range may be between the start time point of the next valid time period for localized services in SNPN and the end time point of the next valid time period for localized services in SNPN, if the next valid time period is no longer than 30 minutes. For other 5GMM cause values, the range may be between the start time point of the next valid time period for localized services in SNPN and 60 minutes after the start time point of the next valid time period for localized services in SNPN, if the next valid time period is longer than 60 minutes. Alternatively, for other 5GMM cause values, the range may be between the start time point of the next valid time period for localized services in SNPN and the end time point of the next valid time period for localized services in SNPN, if the next valid time period is no longer than 60 minutes. Otherwise, the range may be between the start time point of the next valid time period for localized services in SNPN and: (a) 15 minutes and 30 minutes for 5GMM cause value #74; or (b) 30 minutes and 60 minutes for other 5GMM cause values;

Under a second proposed scheme in accordance with the present disclosure, when UE 110 adds an SNPN to a “permanently forbidden SNPNs for access for localized services in SNPN” list or a “temporarily forbidden SNPNs for access for localized services in SNPN” list which are associated with a selected entry of the “list of subscriber data” or a selected PLMN subscription for a 3GPP access or a non-3GPP access, and timer T3245 is not running, then UE 110 may start timer T3245. In an event that there is no next valid time period for the SNPN, UE 110 may start timer T3245 with a random value, uniformly drawn from the range between 12 hours (12 h) and 24 hours (24 h). Alternatively, or additionally, in an event that there is next valid time period for the SNPN, UE 110 may start timer T3245 with a random value uniformly drawn from the range between the start time point and the end time point of the next valid time period for localized services in the SNPN.

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to starting a non-integrity timer in localized services in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network, or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged, and configured to perform specific tasks including those pertaining to starting a non-integrity timer in localized services in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., network node 125) of a network (e.g., wireless network 120 as a 5G/NR mobile network), is provided below in the context of example processes 300 and 400.

### Illustrative Processes

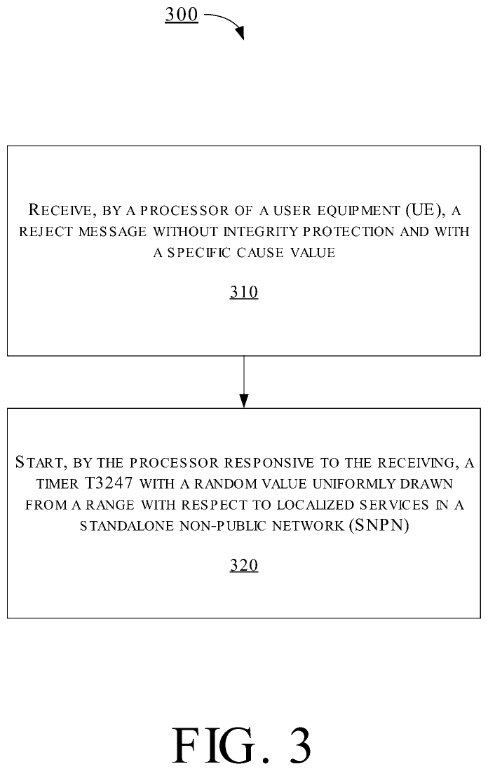

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to starting a non-integrity timer in localized services in mobile communications in accordance with the present disclosure. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively, in a different order. Furthermore, one or more of the blocks/sub-blocks of process 300 may be executed repeatedly or iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., network node 125) of a network (e.g., wireless network 120). Process 300 may begin at block 310.

At 310, process 300 may involve processor 212 of apparatus 210 receiving, via transceiver 216, a reject message without integrity protection and with a specific cause value (e.g., from wireless network 120 via apparatus 220 as network node 125). Process 300 may proceed from 310 to 320.

At 320, process 300 may involve processor 212 starting, responsive to the receiving, a timer T3247 with a random value uniformly drawn from a range with respect to localized services in an SNPN.

In some implementations, the range may include a range between a start time point of a next valid time period for the localized services in the SNPN and an end time point of the next value time period for the localized services in the SNPN. In some implementations, the specific cause may include a 5GMM cause #74 or a 5GMM cause #75.

In some implementations, the range may be a range between a start time point of a next valid time period for the localized services in the SNPN and an end time point of the next value time period for the localized services in the SNPN in an event that the next valid time period is no longer than 30 minutes. Alternatively, the range may be a range between a start time point of a next valid time period for the localized services in the SNPN and an end time point of the next value time period for the localized services in the SNPN in an event that the next valid time period is no longer than 60 minutes.

In some implementations, the reject message may include a REGISTRATION REJECT message or a SERVICE REJECT message.

In some implementations, the SNPN may be an SNPN that was selected for a specific access type for which the reject message is received.

FIG. 4 illustrates an example process 400 in accordance with an implementation of the present disclosure. Process 400 may represent an aspect of implementing various proposed designs, concepts, schemes, systems and methods described above. More specifically, process 400 may represent an aspect of the proposed concepts and schemes pertaining to starting a non-integrity timer in localized services in mobile communications in accordance with the present disclosure. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively, in a different order. Furthermore, one or more of the blocks/sub-blocks of process 400 may be executed repeatedly or iteratively. Process 400 may be implemented by or in apparatus 210 and apparatus 220 as well as any variations thereof. Solely for illustrative purposes and without limiting the scope, process 400 is described below in the context of apparatus 210 as a UE (e.g., UE 110) and apparatus 220 as a communication entity such as a network node or base station (e.g., network node 125) of a network (e.g., wireless network 120). Process 400 may begin at block 410.

At 410, process 400 may involve processor 212 of apparatus 210 adding a standalone non-public network (SNPN) to a list of forbidden SNPNs. Process 400 may proceed from 410 to 420.

At 420, process 400 may involve processor 212 starting, responsive to the adding, a timer T3245 in an event that the timer T3245 is not running.

In some implementations, in starting the timer T3245, process 400 may involve processor 212 starting the timer T3245 with a random value uniformly drawn from a range between 12 hours and 24 hours responsive to there being no next valid time period for the SNPN.

In some implementations, in starting the timer T3245, process 400 may involve processor 212 starting the timer T3245 with a random value uniformly drawn from a range between a start time point and an end time point of a next valid time period for localized services in the SNPN responsive to the next valid time period existing for the SNPN.

In some implementations, in adding the SNPN to the list of forbidden SNPNs, processor 212 starting the timer T3245 adding the SNPN to a “permanently forbidden SNPNs for access for localized services in SNPN” list or a “temporarily forbidden SNPNs for access for localized services in SNPN” list which are associated with a selected entry of a “list of subscriber data” or a selected PLMN subscription for a 3GPP access or a non-3GPP access.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), a reject message without integrity protection and with a specific cause value; and
starting, by the processor responsive to the receiving, a timer T3247 with a random value uniformly drawn from a range with respect to localized services in a standalone non-public network (SNPN).

2. The method of claim 1, wherein the range comprises a range between a start time point of a next valid time period for the localized services in the SNPN and an end time point of the next value time period for the localized services in the SNPN.

3. The method of claim 2, wherein the specific cause comprises a 5^{th} Generation Mobility Management (5GMM) cause #74.

4. The method of claim 2, wherein the specific cause comprises a 5^{th} Generation Mobility Management (5GMM) cause #75.

5. The method of claim 2, wherein the range comprises the range between a start time point of a next valid time period for the localized services in the SNPN and an end time point of the next value time period for the localized services in the SNPN in an event that the next valid time period is no longer than 30 minutes.

6. The method of claim 2, wherein the range comprises the range between a start time point of a next valid time period for the localized services in the SNPN and an end time point of the next value time period for the localized services in the SNPN in an event that the next valid time period is no longer than 60 minutes.

7. The method of claim 1, wherein the reject message comprises a REGISTRATION REJECT message or a SERVICE REJECT message.

8. The method of claim 1, wherein the SNPN was selected for a specific access type for which the reject message is received.

9. A method, comprising:
adding, by a processor of a user equipment (UE), a standalone non-public network (SNPN) to a list of forbidden SNPNs; and
starting, by the processor responsive to the adding, a timer T3245 in an event that the timer T3245 is not running.

10. The method of claim 9, wherein the starting of the timer T3245 comprises starting the timer T3245 with a random value uniformly drawn from a range between 12 hours and 24 hours responsive to there being no next valid time period for the SNPN.

11. The method of claim 9, wherein the starting of the timer T3245 comprises starting the timer T3245 with a random value uniformly drawn from a range between a start time point and an end time point of a next valid time period for localized services in the SNPN responsive to the next valid time period existing for the SNPN.

12. The method of claim 9, wherein the adding of the SNPN to the list of forbidden SNPNs comprises adding the SNPN to a “permanently forbidden SNPNs for access for localized services in SNPN” list or a “temporarily forbidden SNPNs for access for localized services in SNPN” list which are associated with a selected entry of a “list of subscriber data” or a selected public land mobile network (PLMN) subscription for a 3^{rd} Generation Partnership Project (3GPP) access or a non-3GPP access.
